(19) United States
(12) Patent Application Publication
(10) Pub. No.: US 2004/0051475 A1
(43) Pub. Date: Mar. 18, 2004

(54) Instant start of series lamp combination

(75) Inventor: John M. Griffin, Morton Grove, IL (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/246,653

(22) Filed: Sep. 18, 2002

(51) Int. Cl. H05B 39/04

(52) U.S. Cl. 315/291; 315/209 CD

(57) ABSTRACT

An illumination circuit includes a ballast, a capacitor, a first lamp and a second lamp. The capacitor and the second lamp constitute a first operative current path for igniting the second lamp by a coupling of the capacitor to a first node and a second node, and a coupling of the second lamp to the second node. A ballast, the first lamp and the second lamp constitute a second operative current path for igniting the first lamp by a coupling of the ballast to the first node, a coupling of the first lamp to the second node, and a series coupling of the ballast and the first lamp.

### TECHNICAL FIELD

The present invention generally relates to fluorescent lamps. The present invention specifically relates to an operation of a sequential ignition of two fluorescent lamps.

### BACKGROUND AND SUMMARY OF THE INVENTION

FIG. 1 illustrates a known illumination circuit 10 between a SUPPLY and a RETURN. The illumination circuit 10 has a capacitor C_{B} (representative of a ballast) coupled to a node N1 and a node N2, with the SUPPLY being coupled to the node N1. A parallel coupling of a lamp 20a and a capacitor C_{S} are coupled to the node N2 and a node N3. And, a lamp 20b is coupled to the node N3 and the RETURN.

In operation, lamps 20a and 20b are sequentially ignited. Specifically, upon a supply voltage V_{SS} being applied to the node N1, the capacitor C_{S1} acts as a short to thereby establish a lamp current path I_{P1}, for igniting the lamp 20b whereby a magnitude of a lamp voltage V_{L1} across the lamp 20a is zero (0) volts and a magnitude of a lamp voltage V_{L2} across the lamp 20b approximates a ballast output voltage V_{B} applied to the node N2. After an ignition of the lamp 20b, the lamp voltage V_{L1} across the lamp 20a increases to a difference between the supply voltage V_{SS} and the lamp voltage V_{L2} (i.e., V_{SS}−V_{L2}) to thereby sequentially ignite the lamp 20a. After both lamps 20a and 20b have been ignited, current flowing through the lamps 20a and 20b along a current path I_{P2} is controlled by the capacitor C_{B}.

A drawback of the FIG. 1 illumination circuit 10 is a capacitance of the capacitor C_{S1}, must equate or be greater than a capacitance of the capacitor C_{B} in order to guarantee ignition of the lamp 20b. However, after ignition of the lamps 20a and 20b, current flowing through the capacitor C_{S1} is parasitic and therefore does not contribute to the light output of the lamps 20a and 20b during normal operation. The present invention addresses the aforementioned drawback of FIG. 1.

Various aspects of the present invention are novel, non-obvious, and provide various advantages. While the actual nature of the present invention covered herein can only be determined with reference to the claims appended hereto, certain features, which are characteristic of the embodiments disclosed herein, are described briefly as follows.

The present invention is an illumination circuit comprising a ballast, a capacitor, a first lamp and a second lamp. In one form, the ballast and the capacitor are coupled to a first node, the capacitor and the pair of lamps are coupled to a second node, and the ballast is further coupled to the first lamp. In a second form, a series coupling of the ballast and the first lamp is coupled in parallel to the capacitor, and the second lamp is coupled to the parallel coupling of the series coupling and the capacitor. In a third form, an operative current path for igniting the second lamp consists of the capacitor and the second lamp, and an operative current path for igniting the first lamp consists of the ballast and the pair of lamps.

The foregoing forms as well as other forms, features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

### BRIEF DESCRIPTION OF THE DRAWINGS

FIG. 1 illustrates a diagram of an illumination circuit known in the art;

FIG. 2 illustrates a diagram of an illumination circuit in accordance with the present invention;

FIG. 3 illustrates an exemplary signal waveform indicative of an ignition time of lamps by the FIG. 1 illumination circuit; and

FIG. 4 illustrates an exemplary signal waveform indicative of an ignition time of lamps by the FIG. 3 illumination circuit.

### DETAILED DESCRIPTION OF THE INVENTION

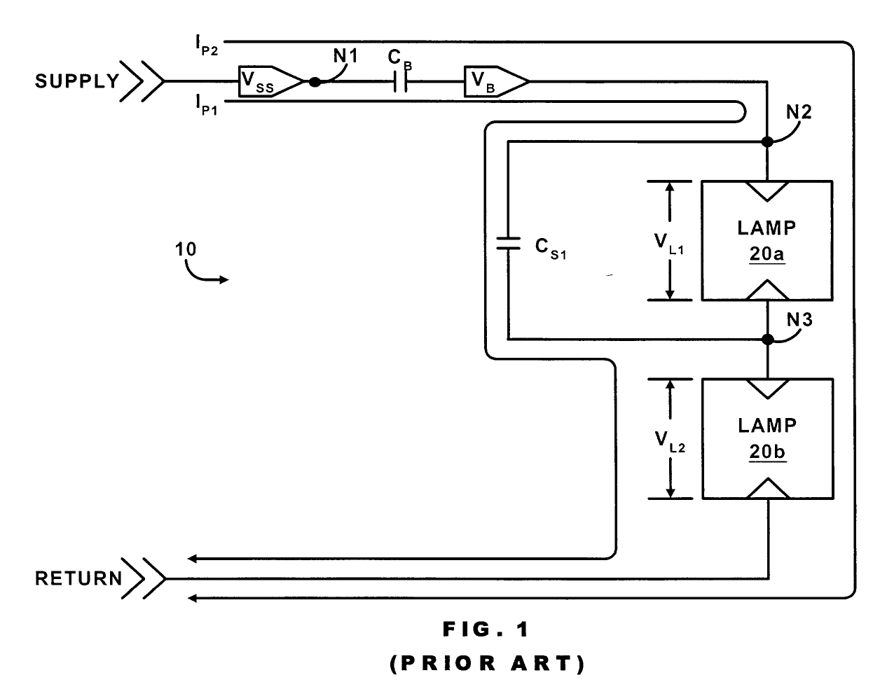

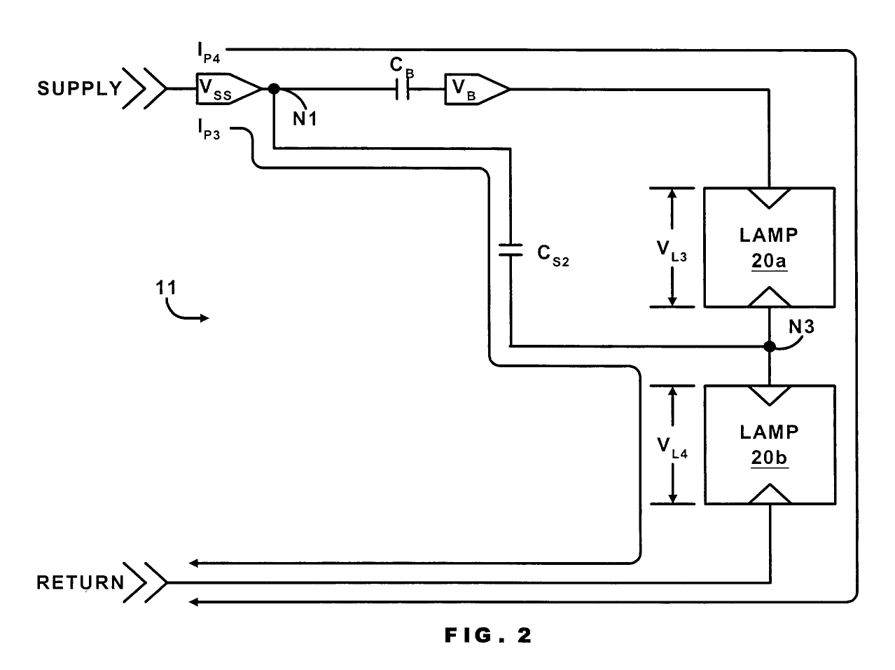

FIG. 2 illustrates an illumination circuit 11 in accordance with the present invention. In lieu of capacitor C_{S1} (FIG. 1), the illumination circuit 11 has a capacitor C_{S2} coupled to the node N1 and the node N3. The capacitor C_{B} (again, representative of a ballast) is coupled to the lamp 20a, which is coupled to the node N3. And, the lamp 20b is coupled to the node N3 and the RETURN.

In operation, lamps 20a and 20b are sequentially ignited. Specifically, upon the supply voltage V_{SS} being applied to the node N1, the capacitor C_{S2} acts as a short to thereby establish a lamp current path I_{P3} for igniting the lamp 20b whereby a magnitude of a lamp voltage V_{L3} across the lamp 20a is zero (0) volts and a magnitude of a lamp voltage V_{L4} across the lamp 20b approximates the supply voltage V_{SS}. After an ignition of the lamp 20b, the voltage V_{L3} across the lamp 20a increases to a difference between the supply voltage V_{SS} and the lamp voltage V_{L4} (i.e., V_{SS}−V_{L4}) to thereby sequentially ignite the lamp 20a. After both lamps 20a and 20b have been ignited, current flowing through the lamps 20a and 20b along a current path I_{P4} is controlled by the capacitor C_{B} and a current through flowing the capacitor C_{S2} along the current path I_{P3} is negligible.

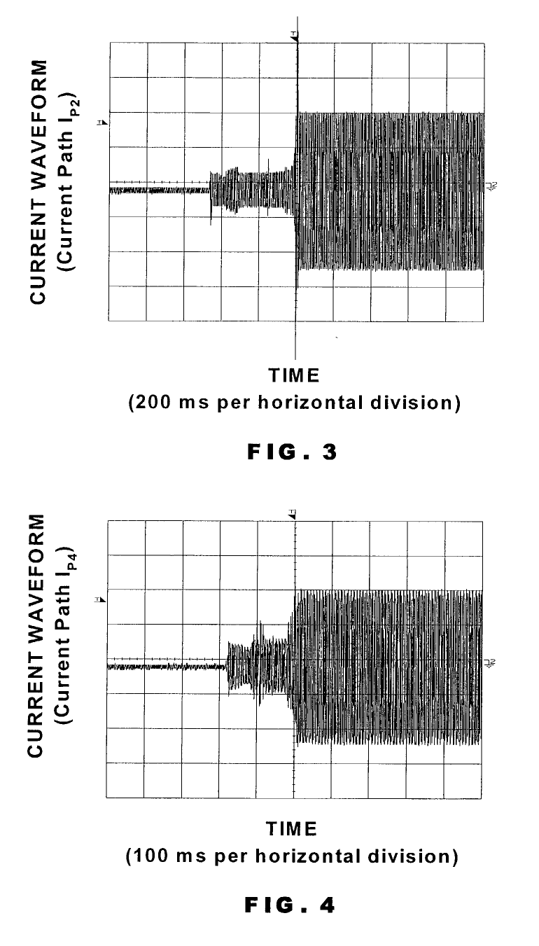

FIG. 3 illustrates an exemplary signal waveform of an ignition time of approximately 500 ms for the lamps 20a and 20b as employed in the illumination circuit 10 (FIG. 1). FIG. 4 illustrates an exemplary signal waveform of an ignition time of approximately 180 ms for lamps 20a and 20b as employed in the illumination circuit 11 (FIG. 2). From FIGS. 3 and 4, those having ordinary skill in the art will appreciate that the illumination circuit 11 is an unique combination of an instant start series combination of lamps 20a and 20b which results in longer lamp life by a decrease in the ignition time of the lamps 20a and 20b.

The illustrated couplings of the various components of illumination circuit 11 can be achieved in many ways (e.g., optically, magnetically, acoustically, and preferably, electrically via conductors). Also, alternative embodiments of the illumination circuit 11 can include additional components to enhance the functionality of the illumination circuit 11 without any altering the illustrated couplings in FIG. 2.

While the embodiments of the present invention disclosed herein are presently considered to be preferred, various changes and modifications can be made without departing from the spirit and scope of the present invention. The scope of the present invention is indicated in the appended claims, and all changes that come within the meaning and range of equivalents are intended to be embraced therein.

### IN THE SPECIFICATION

The present invention generally relates to fluorescent lamps. The present invention specifically relates to an operation of athe sequential ignition of two series connected fluorescent lamps. Page 4, in the paragraph beginning on line 12, please amend as follows:

FIG. 4 illustrates an exemplary signal waveform indicative of an ignition time of lamps by the FIG. 32 illumination circuit. Page 5, in the paragraph beginning on line 15, please amend as follows:

The illustrated couplings of the various components of illumination circuit 11 can be achieved in many ways (e.g., optically, magnetically, acoustically, and preferably, electrically via conductors). Also, alternative embodiments of the illumination circuit 11 can include additional components to enhance the functionality of the illumination circuit 11 without any altering alteration of the illustrated couplings in FIG. 2.

I claim:

1. An illumination circuit, comprising:
a ballast coupled to a first node;
a capacitor coupled to the first node and a second node;
a first lamp coupled to said ballast and the second node; and
a second lamp coupled to the second node.

2. An illumination circuit, comprising:
a ballast;
a first lamp;
a series coupling of said ballast and said first lamp;
a capacitor;
a parallel coupling of said capacitor and said series coupling; and
a second lamp coupled to said parallel coupling.

3. An illumination circuit, comprising:
a ballast;
a capacitor;
a first lamp; and
a second lamp
wherein a first operative current path for igniting said second lamp consists of said capacitor and said second lamp, and
wherein a second operative current path for igniting said first lamp consists of said ballast, said first lamp and said second lamp.
